(19) United States
(12) Patent Application Publication
(10) Pub. No.: US 2007/0050471 A1
(43) Pub. Date: Mar. 1, 2007

(54) Portable Remoting Component With A Scaleable Feature Set

(75) Inventors: Jeson Patel, Redmond, WA (US); Nadim Y. Abdo, Bellevue, WA (US); Nelly Porter, Redmond, WA (US); Joy Chik, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/379,955

(22) Filed: Apr. 24, 2006

Related U.S. Application Data
(60) Provisional application No. 60/712,994, filed on Aug. 31, 2005.

(51) Int. Cl. G06F 15/16

(52) U.S. Cl. 709/217

(57) ABSTRACT

A client device that includes a scaled remote protocol platform to support communication using a particular remote protocol A software and hardware platform independent micro core or micro client exposes interfaces in the client device to applications to support remote communication. The micro core may be extended to include additional features or service as needed by the client device.

### RELATED APPLICATIONS

The present application claims priority under 35 U.S.C. §119(e) to U.S. Provisional Application No. 60/712,994, filed Aug. 31, 2005, the disclosure of which is incorporated herein.

### BACKGROUND

Remote client access platforms and systems allow computing devices or client devices to remotely access data from application programs hosted by and resident at an application server or servers (server computer). Client devices can include personal computers, personal communication devices (e.g., cellular phones), set top boxes, gaming units, television sets, etc.

For certain client devices, such as a television-based client device, communication between the server computer and client device may only involve the receiving of data or information from the server computer. For other client devices, there may be significant two-way conununication between the server computer and the client device, where the client device is a computing device (e.g., a personal computer) that is sending data or information to the server computer. Furthermore, the quality of data or information, such as graphics data, may be different for client devices. For example, a cellular telephone over a wireless network does not need or cannot process the same amount of graphics information sent to a personal computer over a broadband network.

Communication between the server computer and client devices typically involves the use of a communication protocol, such as remote data protocol or RDP. Lower level network protocols such as transmission control protocol over Internet protocol (TCP/IP) may also be involved. A communication platform is provided at the client device to support a particular communication protocol. A client device particularly equipped to support RDP communications may be referred to as an RDP client.

A client device supporting a protocol specific communication platform, such as an RDP client, may be limited in its portability and scalability. As to portability limitations, the protocol specific client device may not be supported by other operating systems (i.e., software platforms) and/or hardware platforms. Scalability limitations include the need to provide a scaled or reduced feature set to specific client devices. As discussed above, certain client devices may not need or cannot support particular feature sets such as communication back to the server computer, rich graphics (i.e., graphics information typically sent to a personal computer), etc.

It is usual that in order to support a particular protocol for a specific client device, the communications platform is modified to support the client device. For example, the code base of the communications platform may be significantly modified to support a specific client device. Since there can be many client devices with different needs and processing resources, case by case modification of a communication platform for different client devices can be a significant expense. Furthermore, providing code base to perform such modification may involve the owner of the code base to provide proprietary information to third parties.

### SUMMARY

A scaled set of features or services for a remote protocol platform are defined for multiple client devices, and particularly implemented at a client device. The remote protocol platform is based on a particular remote protocol. Application program interfaces (interfaces) are created to support each feature or service. A component communicates with the interfaces and exposes the interface to applications in the client device and allows remote communication based on the particular remote protocol.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

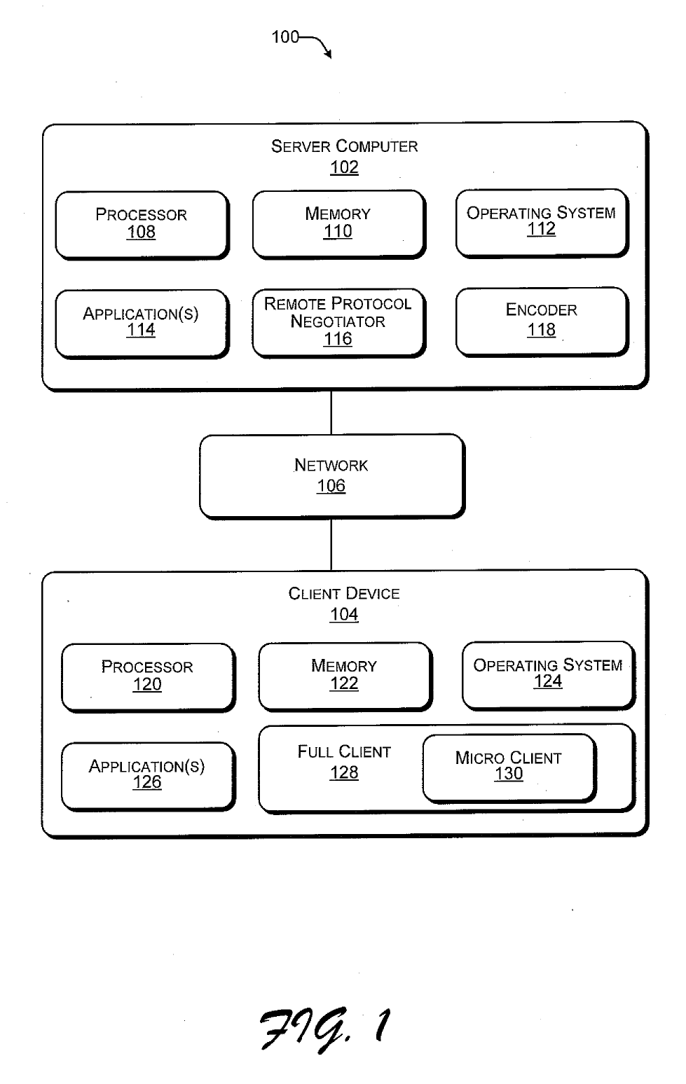

FIG. 1 is an illustration of an exemplary server-client system that supports a full client feature set or a micro client feature set of a remote protocol platform.

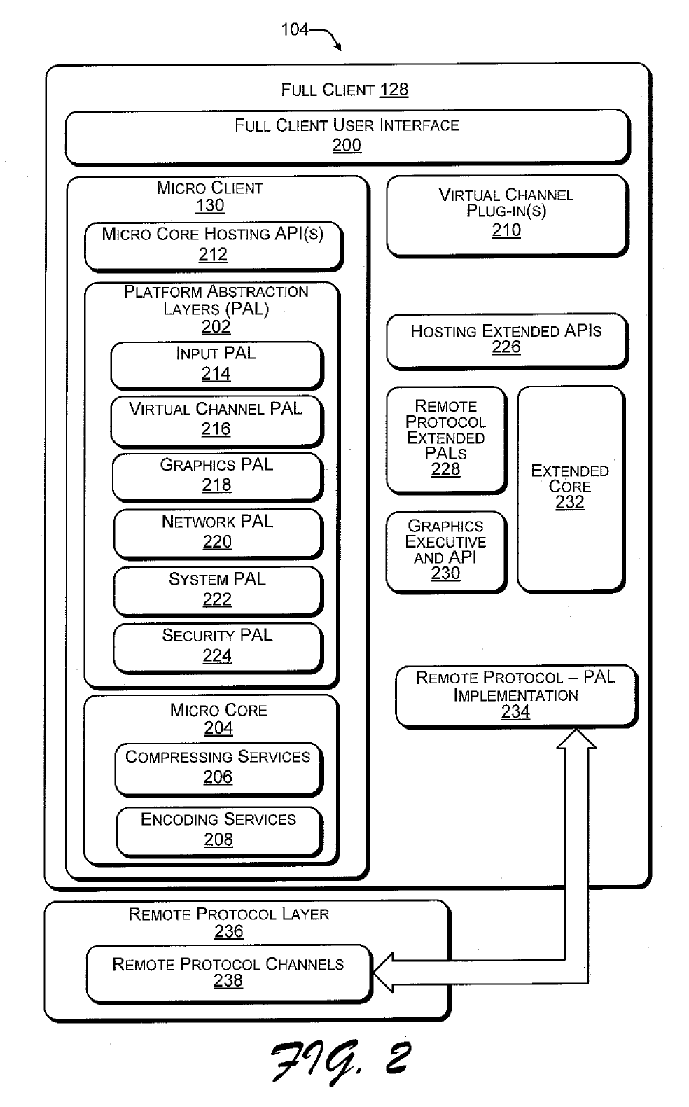

FIG. 2 is an illustration of an exemplary client device that includes a full client component that includes a micro client component.

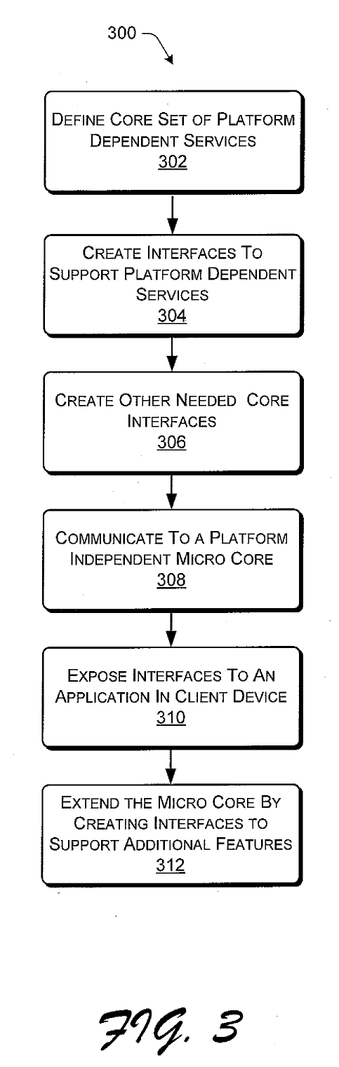

FIG. 3 is a flowchart illustrating a process for providing platform independent application program interfaces through a micro core component.

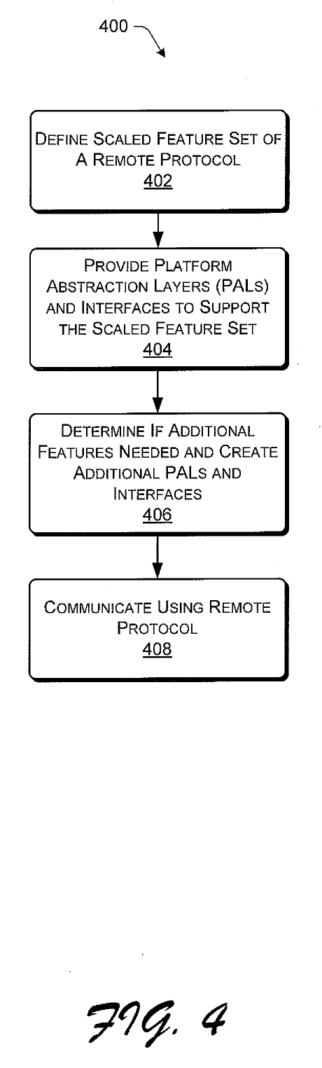

FIG. 4 is a flowchart illustrating a process for providing a scaled and extensible feature set of a remote protocol platform supporting a particular remote protocol.

### DETAILED DESCRIPTION

FIG. 1 shows an exemplary server-client system 100. System 100 includes a server computer 102 and one or more client devices as represented by client device 104. The client device 104 may include personal computers (PC) such as desktops and laptops; personal computing devices such as personal digital assistants and cellular telephones; and multimedia devices such as gaming units, set top boxes, and television sets. Server computer 102 and client device 104 are connected by a network 106 which may include one or more networks, including the Internet. The server computer 102 and client device 104 are configured to use a particular remote protocol, such as remote data protocol or RDP, for communications. Client device 104 includes a remote protocol platform that comprises a scaled or minimal subset of features typically supported by a fully featured remote protocol platform. In other words, regardless of the type or capability of client device 104, client device 104 includes a minimal subset of features to support the remote protocol. As further discussed below, client devices that require additional features of the remote protocol or a “fully featured” protocol platform are supported by an extensible core and interfaces.

Server computer 102 includes a central processing unit or processor 108 and a memory 110. Further included in server computer 102 is an operating system 112 and one or more application programs or applications 114. Server computer 102 also includes a remote protocol negotiator 116 and an encoder 118. Protocol negotiator 116 is configured to support communications between the server computer 102 and the client device 104 based on the particular remote protocol. In addition, the particular remote protocol that is used may involve providing data packets representative of information and/or encoding of data. Encoder 118 may be used to package or structure communication packets from the server computer 102 to the client device 104.

The client device 104 includes a central processing unit or processor 120 and a memory 122. Client device 104 also includes an operating system 124, and one or more application programs or applications 126. The client device 104 further includes a full client 128 that provides an interface or communications to the server computer 102. In particular, full client 128 may be implemented as a component or protocol platform that supports communication using the particular remote protocol. Full client 128 includes reduced featured set micro client 130. In general, the micro client 130 is particularly configured for client device 104, and is portable to support multiple software and hardware platforms (i.e., platform independent); scalable in that includes a minimal subset of features that support the remote protocol; and extensible to provided additional needed features beyond what is provided by micro client 130. As further discussed below, micro client 130 and any extensions, such as interfaces, are included in the full client 128.

FIG. 2 is a block diagram further illustrating the client device 104 that includes the full client 128 and the micro client 130. Client computer 104 includes the full client 128 which further includes a full client user interface 200. The full client user interface 200 may particularly be used to communicate with a server computer (e.g., server computer 102), regardless of whether any communication features are provided with micro client 130. In other words, there is no distinction in interfaces as to whether the client device 104 is a reduced featured set supported by solely by micro client 130 or a full feature set remote protocol platform having multiple extensions (e.g., interfaces). It is contemplated that in certain cases only a graphics only user interface is implemented where no input is supported. In such cases, the user interface would be different than a client that supports input.

The micro client 130 includes common platform abstraction layers (PALs) 202 that are applicable to multiple devices. PALs 202 are a common set of defined interfaces that support services of a remote protocol platform, such as an RDP platform. Exemplary PALs that may be included in PALS 202 are further described below.

PALs 202 may interface to a micro core 204. Or alternatively viewed, micro core 204 may expose PALs 202 to an application or application program. The micro core 204 relies on PALs 202 for remote protocol platform specific services, examples of which are discussed below in reference to exemplary PALs. Although the micro core 204 (or the micro client 130) may not be an application, it may be a component integrated into an application. For example, micro core 204 may be part of a multimedia application.

The micro core 204 includes common functions used or features used by client devices. In this example, micro core 204 includes compressing services 206 that may be used to compress data to a server computer (e.g., server computer 102) and an encoding services 208 to encrypt or encode data or data packets to the server computer (e.g., server computer 102). Other functions that may be provided by the micro core 204 include establishing a remote protocol connection; rendering a minimal set of remote protocol graphics (e.g., RDP graphics) that may include screen data and block transfers; sending input data or events from an input device such as a keyboard or mouse; and enabling and sending data through virtual channels. Virtual channel plug-in(s) 210 is particularly provided for such virtual channel communications.

In general, micro core 204 provides a scaled set of features (i.e., scaled feature set) provided by a particular remote protocol. The scaled feature set is what is commonly used by different client devices. For example, the scaled feature set may particularly be used in commercial embedded client devices (e.g., television sets) or client devices that offer differing software and hardware capabilities.

In addition to exposing PALs 202 to an application (e.g., applications 126 in client computer 104), micro core 204 may expose other application program interfaces (API). Such APIs are represented by micro core hosting API 212 and can include a top level API for controlling the micro core 204 and providing a mechanism to establish and disconnect a remote protocol session, including the ability to set a number of properties of the remote protocol session (e.g., color depth and resolution). Another API may include an interface that allows an application or application layer to receive notification regarding important state changes within the micro core 204. Examples of state changes include successful or unsuccessful connection, disconnection, and auto reconnection.

The micro core 204 is software and hardware platform independent, and thus is portable, by providing basic or common interfaces through PALs 202 and common APIs described above. The above described APIs and PALs 202 are common to client devices regardless of the hardware and software platforms of the client devices. Therefore, portability comes from a common code base in a common feature set of APIs and PALs 202 that transcend or are accessible by various hardware and software platforms. In certain implementations, the micro core 204 may provide extensibility points to extend its functionality, providing a small subset of functionality for the micro core 204 while still having the ability to provide the features of a particular operating system, but in a platform independent manner.

The following are exemplary PALs that may be included in PALs 202. It is to be understood that PALs 202 may include fewer PALs and/or different PALS. Furthermore, other APIs or interfaces may be exposed by micro core 204.

An input PAL 214 is an abstraction for an input source. Input events generated by hardware are sources by the input PAL 214 and sent to the micro core 204 to be sent to server computer (e.g., server computer 102) through the remote protocol. The micro core 204 understands that an input event should be sent to the server computer, and plays no role in how the events are generated.

Virtual channels may be implemented in a platform independent manner in the micro core 204; however, the virtual channel plug-in(s) 210 may be platform dependent. Specifically, the way in which the virtual channel plug-in(s) 210 are loaded may be platform dependent. If virtual channel plug-in(s) 210 are dynamically loaded, then loading relies on an operating system mechanism to load dynamic code. A virtual channel PAL 216 provides an interface for the micro core 204 to enumerate and load the virtual channel plug-in(s) 210. In addition, the virtual channel PAL 216 provides a mechanism for virtual channel traffic to flow through specific threads.

A graphics PAL 218 is an interface that allows the micro core 204 to render decoded remote protocol graphics data. The graphics PAL 218 provides a set of drawing operations which can be applied to a drawing surface. A drawing surface is an abstraction for the “output” display which includes a physical display (e.g., a monitor), a printer, or an input to a memory buffer. An example of a drawing operation on the graphics PAL 218 is “draw a rectangle that is blue, 10×10 pixels, and located as position x=50, y=75”.

A network PAL 220 is an abstraction for network communication. The micro core 204 relies on the network PAL 220 to establish a connection, and send data back and forth with the server computer (e.g., server computer 102). The actual network communication protocol may be abstracted from the micro core 204. The micro core 204 understands that it can connect, disconnect, and send and receive data. Possible network PAL 220 implementations could use transmission control protocol (TCP), secure sockets layer (SSL), and/or serial protocols.

A system PAL 222 is a platform independent operating system API. The system PAL 222 includes, but is not limited to, functions for memory management, locking, timers, threads, etc. In general, micro core 204 relies on the system PAL 222 for operating system level services. A security PAL 224 is an abstraction for a number of the security functions that the micro core 204 uses to implement security and licensing layers of the remote protocol.

Extensibility is directed to supporting client devices that have greater or additional platform requirements (e.g., software, hardware, communication platforms) than what are provided in the common feature set of APIs and PALs 202 provided in the micro client 130. To support extensibility of unique properties of particular platforms, full client 128 may include a hosting extended application program interfaces (API) 226 which provide particular extended interfaces. Furthermore, PALs that are specific to particular requirements or a full feature set are provided through remote protocol extended PALs 228. In certain cases, a specific graphics executive and AP 230 may be provided.

An extended core 232 may be implemented to expose the hosting extended APIs 226, remote protocol extended PALs 228, and graphics executive and API 230. In certain implementations, the extended core 232 may include the micro core 204 and any platform independent extensions (e.g., PALs 202).

Communication or data/information communicated through the various interfaces, PALs 202, PALS 228, is processed through a component referred to as a remote protocol PAL implementation 234 which is provided to specifically support the particular remote protocol. The remote protocol PAL implementation 234 may receive API call streams to particular interfaces (e.g., PALs). Data/information communicated from the remote protocol PAL implementation 234 may be communicated through a secure socket layer or other channels, as represented by remote protocol channels 238. Remote protocol channels 238 also represent channels to the server computer (e.g., server computer 102). Remote protocol layer 236 represents the particular remote protocol in which the data/information is communicated. For example, remote protocol layer may be an RDP layer.

FIG. 3 shows a process 300 that provides for or exposes application program interfaces (API). The process 300 may be implemented at a client device through a micro core. The process 300 is illustrated as a collection of blocks in a logical flow graph, which represent a sequence of operations that can be implemented in hardware, software, firmware, or a combination thereof. In the context of software, the blocks represent computer instructions that, when executed by one or more processors, perform the recited operations. Although described as a flowchart, it is contemplated that certain blocks may take place concurrently or in a different order. The process 300 may be implemented, for example, by the system 100 of FIG. 1, client device 104 and micro core 204, although the process 300 may be implemented by other architectures.

At block 302, a core set of platform dependent services is defined. Such services may include graphics interfacing, network interfacing, input interfaces from devices, channels (e.g., virtual channels), hardware system and/or operating system, and security. The core set of dependent services are expected to be used by any client device implementing a particular remote protocol and remote protocol platform.

At block 304, well defined interfaces or platform abstraction layers (PALs) are created. Each of the PALs support a particular platform dependent service as defined in block 302. For example, there is a PAL that supports graphics, a PAL that supports network interfacing, a PAL that supports systems, and a PAL that supports security.

At block 306, other core interfaces may be created as needed. These core interfaces are in addition to the PALs created in block 304. Examples of such interfaces, and functions that they provide, include a top level API for controlling a component such as micro core 204, and providing a mechanism to establish and disconnect a remote protocol session, including the ability to set a number of properties of the remote protocol session. Another interface may be an API that allows an application or application layer to receive notification regarding important state changes within the component (e.g., micro core 204). Examples of state changes include successful or unsuccessful connection, disconnection, and auto reconnection.

At block 308, the PALs and interfaces are communicated or are made available to the component or micro core (e.g., micro core 204). The micro core is platform independent, meaning that the micro core may be used by or ported over to different hardware and software platforms. In other words, the PALs and interfaces allow a client to be platform (hardware and software) independent.

At block 310, the micro core exposes the interfaces including the PALs to an application in the client device. Applications include application programs that support input and output devices such as keyboards, mice, output displays, etc.

At block 312, in order to support additional features or a fully feature set found in a particular remote protocol platform, additional interfaces and PALs may be provided. The addition of interfaces and PALs effectively extends the functionality of the micro core.

FIG. 4 shows a process 400 that provides for a scaled and extended feature set for a remote protocol platform. The process 400 may be implemented at a client device which communicates to a server computer using the remote protocol. The process 400 is illustrated as a collection of blocks in a logical flow graph, which represent a sequence of operations that can be implemented in hardware, software, firmware, or a combination thereof. In the context of software, the blocks represent computer instructions that, when executed by one or more processors, perform the recited operations. Although described as a flowchart, it is contemplated that certain blocks may take place concurrently or in a different order. The process 400 may be implemented, for example, by the system 100 of FIG. 1, and client device 104, although the process 400 may be implemented by other architectures.

At block 402, a scaled feature set for a particular remote protocol is defined. It is expected that a protocol platform supporting the remote protocol will include more features than the needs of the simplest client device. Therefore, the scaled feature set is a minimal feature subset that supports client devices having minimal resource capabilities and feature set requirements as to a remote protocol platform. The subset features are chosen from full features that are provided by a particular remote protocol.

At block 404, platform abstraction layers (PALS) and interfaces to support the scaled feature set are provided. In particular, the PALs and interfaces are used to communicate with applications through a micro core. Each of the PALs is directed to supporting a particular service as part of the remote protocol platform. Examples of services supported or provide by the PALs include graphics interfacing, network interfacing, input interfacing, system interfacing, and security interfacing. The PALs may be specific to platform dependent services; however, the interfaces and PALs, and the micro core in particular, may support or be ported over to various hardware and software platforms. The integration or grouping of the PALs, interfaces, and micro core make up the scaled remote protocol platform.

At block 406, a determination is made if additional features as supported by the remote protocol are needed. The additional features are provided by extending the micro core, and providing for an extended remote protocol platform, by adding the additional interfaces and PALs.

At block 408, communication is performed to the server computer based on the particular remote protocol. An interface may be made available to the micro core to perform communication. The communication may be through an interface representing a full feature client device, and may be over one or more channels, including virtual channels.

### Conclusion

The above-described methods and devices support various platforms using a particular remote protocol at a client device. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method of exposing application program interfaces in a remote client device that supports a remote protocol comprising:
defining a scaled set of services that support a remote protocol platform, wherein the remote protocol platform is based on the remote protocol;
creating application program interfaces that support the scaled set of services; and
exposing the application program interfaces to a resident application in the remote client device.

2. The method of claim 1 wherein the defining a set of services comprises one or more of the following services: graphics interfacing, network interfacing, input interfacing, system interfacing, and security interfacing.

3. The method of claim 1 wherein the creating application program interfaces comprises creating platform abstraction layers (PALs) that are platform independent to the remote client device, wherein each PAL is directed to a particular feature of the set of services.

4. The method of claim 3, wherein each of the PALs is directed to one of the following: graphics interfacing, network interfacing, input interfacing, system interfacing, and security interfacing.

5. The method of claim 1 wherein the creating application program interfaces comprises creating core interfaces whose functions include one or more of the following: controlling a component that performs the exposing; and providing a mechanism to establish a remote protocol session.

6. The method of claim 1 further comprising extending the remote protocol platform by providing additional interfaces to support additional features as supported by the remote protocol.

7. The method of claim 1 further comprising communicating the application program interfaces to a micro core component, wherein the micro core component performs the exposing the application program interfaces to the resident application.

8. A method of providing a scaled remote protocol platform in a client device comprising:
defining features to he provided in the scaled remote protocol platform;
providing client device platform independent interfaces and program abstraction layers (PALs) to support each of the features, wherein a micro core communicates with an application in the client device through interfaces and the PALs; and
grouping the interfaces, the PALs, and the micro core to provide the scaled remote protocol platform.

9. The method of claim 8 wherein the defining features is based on a minimal set of features to support communications using a particular remote protocol.

10. The method of claim 8 wherein the defining features is based on a subset of features provided by a particular remote protocol.

11. The method of claim 8 wherein the providing interfaces and PALs comprises providing one or more of the following services: graphics interfacing, network interfacing, input interfacing, system interfacing, and security interfacing.

12. The method of claim 8 further comprising determining if additional features are needed, and creating interfaces to support the needed features.

13. The method of claim 8 further comprising communicating with a server computer using the scaled remote protocol platform through a full client interface.

14. A client device comprising:
a processor;
a full client remote protocol platform controlled by the processor;
a micro client remote protocol platform that is included in the full client remote protocol platform; and
one or more platform independent interfaces supporting a scaled feature set of services, accessed by the micro client remote protocol platform, wherein the micro client remote protocol platform exposes the interfaces to an application in the client device.

15. The client device of claim 14 wherein the full client remote protocol platform includes a full client interface for communication by the full client remote protocol platform and the micro client remote protocol platform.

16. The client device of claim 14 wherein the micro client comprises a hardware and software platform independent micro core.

17. The client device of claim 14 wherein one or more interfaces comprise one or more platform abstraction layers that support one of the following: graphics interfacing, network interfacing, input interfacing, system interfacing, and security interfacing.

18. The client device of claim 14 wherein the fill client remote protocol platform includes a full client interface for communication by the full client remote protocol platform and the micro client remote protocol platform.

19. The client device of claim 14 wherein the client device is an embedded device.

20. The client device of claim 14 further comprising an extended core that includes additional interfaces that support additional services.
